(19) United States
(12) Patent Application Publication
(10) Pub. No.: US 2009/0153690 A1
(43) Pub. Date: Jun. 18, 2009

(54) Method for determining imaging quality of a camera via a motion sensor and ISO settings

(76) Inventors: Yun-Chin Li, Banciao City (TW); Chin-Lung Yang, Toufen Township (TW); Shih-Chang Han, Taipei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/071,191

(22) Filed: Feb. 19, 2008

(30) Foreign Application Priority Data
Dec. 14, 2007 (TW) 96148020

(51) Int. Cl. H04N 5/228

(52) U.S. Cl. 348/222.1; 348/E05.031

(57) ABSTRACT

A method for determining imaging quality of a camera via a motion sensor and ISO settings uses a CCD sensor module, an ISO setting module, a shutter module, a zoom module and a color temperature module to provide all kinds of information of an object image and transmit the information to an image processing unit to be processed, uses a motion sensor module to provide camera motion information, and then uses the image processing unit to estimate the level of motion of the camera and adjust and correct the information provided by the modules according to the camera motion information provided by the motion sensor module to select optimum settings and compression quality.

### BACKGROUND OF THE INVENTION

1. Field of the Invention

The present invention relates to an imaging method, especially to a method for determining imaging quality of a camera via a motion sensor and ISO settings.

2. Description of Related Art

As shown in FIG. 1, when cameras are in a stationary state, imaging quality of the cameras is generally determined by camera settings, such as ISO settings, shutter time, zoom points and so on. Since imaging quality of cameras is affected by image noise, eliminating image noise may effectively improve the imaging quality. When ISO settings of cameras are high, image sensitivity can be improved, but image noise increases and sharpness and definition of images is reduced. A prior solution is blurring images to suppress noise, so images captured by cameras with high ISO settings are fuzzier than those captured by the cameras with low ISO settings.

However, when cameras are in a state of movement, images captured by the cameras will be fuzzier, which is caused by the movement of the cameras and internal camera settings. For solving the problem, some cameras have a function of compensating movement which is achieved via mounting float sensitive assemblies or float lenses in the cameras to correct horizontal and vertical movements of images caused by camera movement, thereby achieving better imaging quality. But once the magnitude of the movement is large and the movement cannot be corrected by the float sensitive assemblies or float lenses, imaging quality of the cameras is still affected by the movement of the cameras and the internal camera settings. Thus, the images captured by the cameras are still fuzzy.

Hence, the inventors of the present invention believe that the shortcomings described above can be improved and finally suggest the present invention which is of a reasonable design and is an effective improvement.

### SUMMARY OF THE INVENTION

An object of the present invention is to provide a method for determining imaging quality of a camera via a motion sensor and ISO settings which can properly set camera settings according to camera motion information provided by a motion sensor module to prevent images from blurring, thereby obtaining a better and sharp image.

To achieve the above-mentioned object, a method for determining imaging quality of a camera via a motion sensor and ISO settings in accordance with the present invention is provided. The method includes the steps of: capturing and recording information of an object image and transmitting the information to an image processing unit to be processed by a Charge-Coupled Device (CCD) sensor module; providing ISO setting information for the object image and transmitting the ISO setting information to the image processing unit to be processed by an ISO setting module; transmitting shutter time setting information for the object image to the image processing unit to be processed by a shutter module; providing camera motion information and transmitting the camera motion information to the image processing unit to be processed by a motion sensor module; and estimating the level of motion of the camera by the image processing unit according to the camera motion information provided by the motion sensor module, and selecting optimum settings and compression quality by the image processing unit according to the level of motion and the information which is provided by the ISO setting module and the shutter module for obtaining an optimum image.

The efficacy of the present invention is as follows: the present invention improves prior methods for correcting an image via changing ISO settings, shutter time or zoom points during camera movement and the present invention can estimate the level of motion of a camera according to camera motion information provided by the motion sensor module and select corrected optimum settings to improve imaging quality of the camera.

To further understand methods, means and efficacy of the present invention, please refer to the above summary and the following detailed description and drawings related the present invention. Other objects and advantages of the present invention will be explained in the following description and drawings.

### BRIEF DESCRIPTION OF THE DRAWINGS

FIG. 1 is a schematic view showing a prior method for determining imaging quality of a camera;

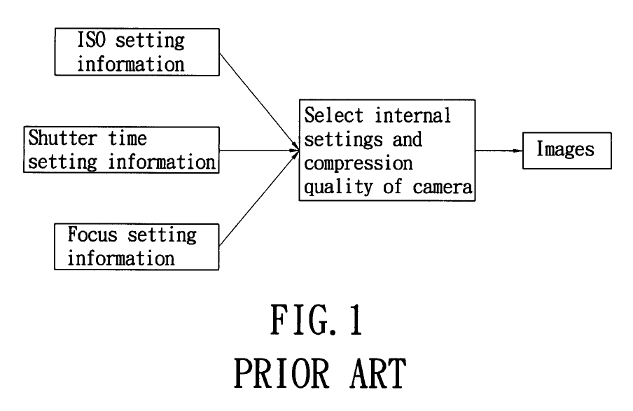

FIG. 2 is a schematic view showing a method for determining imaging quality of a camera via a motion sensor and ISO settings according to the present invention; and

FIG. 3 is a flow chart of the method for determining imaging quality of a camera via a motion sensor and ISO settings according to the present invention.

### DETAILED DESCRIPTION OF THE PREFERRED EMBODIMENTS

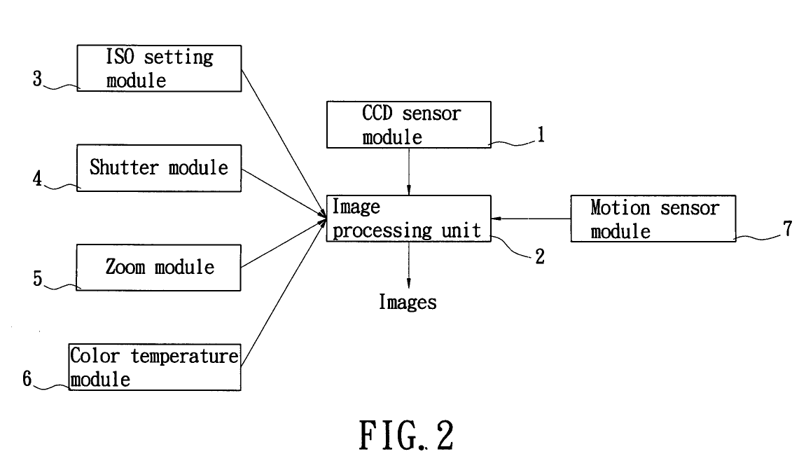

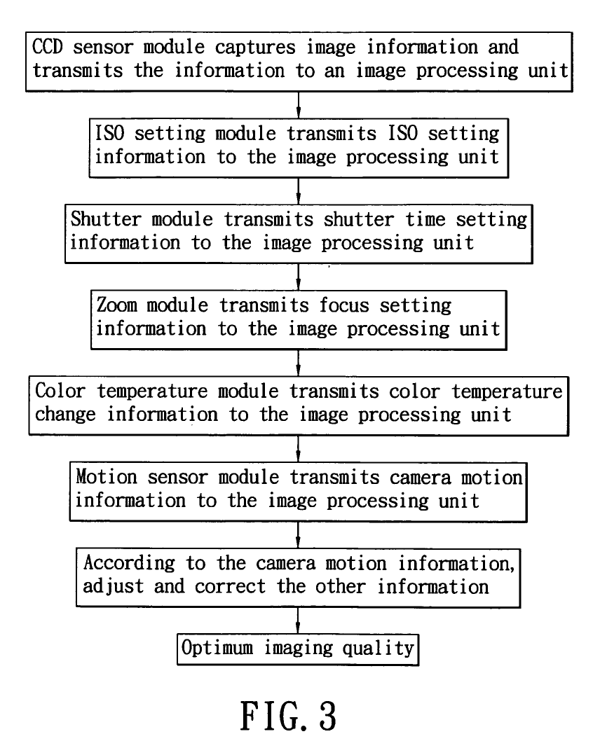

As shown in FIG. 2 and FIG. 3, a method for determining imaging quality of a camera via a motion sensor and ISO settings in accordance with a preferred embodiment of the present invention includes the following steps.

Firstly, a CCD sensor module 1 captures information of an object image which then is recorded in an image processing unit 2 to be processed.

After the information of the object image is recorded in the image processing unit 2, an ISO setting module 3 provides ISO setting information for the object image and transmits the ISO setting information to the image processing unit 2 to be processed.

Then a shutter module 4 provides shutter time setting information for the object image and transmits the shutter time setting information to the image processing unit 2 to be processed.

A zoom module 5 provides focus setting information for the object image and transmits the focus setting information to the image processing unit 2 to be processed.

A color temperature module 6 provides color temperature change information for the object image and transmits the color temperature change information to the image processing unit 2 to be processed.

Further, a motion sensor module 7 senses and records displacement or rotating states of the camera in the direction of X, Y and Z axes, which are caused by movement of the camera, and then computes and processes the displacement or rotating states of the camera to obtain camera motion information. After that, the motion sensor module 7 transmits the camera motion information to the image processing unit 2 to be processed.

Finally, the image processing unit 2 adjusts and corrects the information provided by the CCD sensor module 1, the ISO setting module 3, the shutter module 4, the zoom module 5 and the color temperature module 6 according to the camera motion information provided by the motion sensor module 7, to select optimum settings and compression quality, thereby obtaining an optimum image.

In the method, the motion sensor module 7 is used to determine and record the camera motion information during capturing images. The motion sensor module 7 is an inertial measurement assembly which includes at least one gyroscope (not shown). So the method may compute a displacement or rotating level of motion of the camera in the direction of X, Y and Z axes via the motion sensor module 7 and then adjust the information provided by the CCD sensor module 1, the ISO setting module 3, the shutter module 4, the zoom module 5 and the color temperature module 6 via the image processing unit 2 to obtain an optimum image.

In practice, firstly, assume that the camera is in a rest state and correct camera settings in a general adjusting way. Secondly, considering that the camera is moving, the motion sensor module 7 determines all possible motion modes of the camera during capturing an image and calculates an imaging point spread function (PSF) corresponding to each motion mode. Then, the image captured by the camera is processed according to the point spread functions. Accordingly, for some kind of ISO setting information, the point spread functions corresponding to different levels of motion of the camera may be adopted. Further, optimum settings and compression quality may be selected via adjusting the internal control settings of the camera.

The present invention records the level of motion of the camera and calculates the point spread functions corresponding to the motion modes via the motion sensor module, and then adjusts the camera setting recorded by the modules during camera movement, such as the ISO setting information, the shutter time setting information, the focus setting information, the color temperature change information and so on, according to which the camera creates images during movement, to improve imaging quality, thereby solving the problems caused by camera movement.

What are disclosed above are only the specification and the drawings of the preferred embodiments of the present invention and it is therefore not intended that the present invention be limited to the particular embodiments disclosed. It will be understood by those skilled in the art that various equivalent changes may be made depending on the specification and the drawings of the present invention without departing from the scope of the present invention.

What is claimed is:

1. A method for determining imaging quality of a camera via a motion sensor and ISO settings comprising the steps of:
capturing and recording information of an object image and transmitting the information to an image processing unit to be processed by a Charge-Coupled Device (CCD) sensor module;
providing ISO setting information for the object image and transmitting the ISO setting information to the image processing unit to be processed by an ISO setting module;
transmitting shutter time setting information for the object image to the image processing unit to be processed by a shutter module;
providing camera motion information and transmitting the camera motion information to the image processing unit to be processed by a motion sensor module; and
using the image processing unit to estimate a level of motion of the camera and adjust and correct the information which is provided by the ISO setting module and the shutter module, according to the camera motion information provided by the motion sensor module, to select optimum settings and compression quality for obtaining an optimum image.

2. The method as claimed in claim 1, further comprising the step of: providing focus setting information and transmitting the focus setting information to the image processing unit to be processed by a zoom module.

3. The method as claimed in claim 1, further comprising the step of: providing color temperature change information and transmitting the color temperature change information to the image processing unit to be processed by a color temperature module.

4. The method as claimed in claim 1, wherein the camera motion information shows displacement or rotating states of the camera in the direction of X, Y and Z axes, which are caused by movement of the camera, and the camera motion information is computed and obtained by the motion sensor module.

5. The method as claimed in claim 1, wherein the motion sensor module is an inertial measurement assembly.

6. The method as claimed in claim 5, wherein the inertial measurement assembly includes at least one gyroscope.

7. The method as claimed in claim 1, wherein the motion sensor module determines the level of motion of the camera during capturing the image and calculates an imaging point spread function corresponding to the level of motion of the camera.

8. The method as claimed in claim 7, wherein for the ISO setting information, different point spread functions may be adopted.
